(19) United States
(12) Patent Application Publication
(10) Pub. No.: US 2020/0301883 A1
(43) Pub. Date: Sep. 24, 2020

(54) DATA MANAGEMENT SYSTEM

(71) Applicant: FUJI XEROX CO., LTD., Tokyo (JP)

(72) Inventors: Shigeki KAMIYA, Tokyo (JP); Tetsuo IYODA, Ashigarakami-gun (JP); Akio YAMASHITA, Yokohama-shi (JP)

(73) Assignee: FUJI XEROX CO., LTD., Tokyo (JP)

(21) Appl. No.: 16/504,523

(22) Filed: Jul. 8, 2019

(30) Foreign Application Priority Data
Mar. 22, 2019 (JP) 2019-054007

(51) Int. Cl. G06F 16/14; G06F 16/182

(52) U.S. Cl. CPC G06F 16/148; G06F 16/156; G06F 16/182; G06F 16/144

(57) ABSTRACT

A data management system includes plural of devices in a hierarchical structure, wherein a first device belonging to a hierarchy other than a lowest hierarchy of the hierarchical structure among the plural devices includes a storage unit that stores entity data of a storage target item of the first device among metadata including plural items, and an acquisition unit that acquires link information for specifying entity data of an item group other than the storage target item of the first device among the entity data of the metadata stored in a low-level device relative to the first device in the hierarchical structure.

### CROSS-REFERENCE TO RELATED APPLICATIONS

This application is based on and claims priority under 35 USC 119 from Japanese Patent Application No. 2019-054007 filed on Mar. 22, 2019.

### BACKGROUND

### Technical Field

The present invention relates to a data management system.

### Related Art

An applicant has proposed a document management system having a two-layer structure configured by a management device (or management system) and plural processing devices (please see JP-A-2018-156409, JP-A-2018-156410, JP-A-2018-156411, and JP-A-2018-156383). The processing device generally performs processing of protecting a document registered in the system by encryption or the like, and processing of transmitting the protected document obtained by the processing to a user of transmission destination. The management device manages a processing device group, stores metadata of the protected document generated by the processing device, and provides the stored metadata. The user is registered in a processing device that the user uses as the home. For example, the processing device is provided for each unit of departments and the like of a company, and the user belonging to the unit is registered in the processing device provided for the unit.

The protected document corresponding to the document registered in the system by the user is stored in the processing device that the user uses as the home. Then, the document is transmitted to a terminal of a user of a transmission destination, the user being designated by the user who registered the document and requesting to transmit the document via this processing device or another processing device registered as being safe with respect to the processing device. The protected document is stored in the processing device in which the protected document is registered and in the terminal of the user designated as the transmission destination, but is not stored in the management device, the other processing devices, and the other terminals.

The metadata of a protected document holds information of a user who has an authority such as a browsing authority for the protected document. The information of the authority is registered in the system via a processing device or by a person having an authority such as a user (registrant) who registered the protected document in the system or is changed by the person. When the terminal receives an instruction to browse the protected document in the terminal from a user that operates the terminal, the terminal obtains the latest metadata corresponding to identification information of the protected document via a nearby processing device, and determines whether or not the user currently has the browsing authority for the protected document based on the latest metadata. In a case where it is determined that the user has the browsing authority, the terminal decrypts and displays the protected document using key information in the metadata. Otherwise, the terminal notifies the user that browsing is not permitted.

As described above, this system is configured such that the protected document is stored only in the home processing device of the user who registered the protected document and in the terminal of each user of the transmission destination designated by the user, and thus making it difficult for the protected document to be delivered to a third party.

### SUMMARY

In a management system having a hierarchical structure in which there is a second management device managed by a first management device, sometimes a security problem arises in a case where a highest-level management device (for example, a first management device) manages all entities of data of a management target (hereinafter, referred to as management target data). For example, when a highest-level management device provides a high-level management device with entity of a part of the management target data managed by a low-level management device (for example, a second management device) in order to manage all entities of the management target data, the security problem may arise: in a case where a body (for example, a company) that administers the low-level management device is different from that administers the high-level management device; or in a case where the management target data managed by the low-level management device or data associated with the management target data is data that a user does not want to get out of the low-level management device.

Aspect of non-limiting embodiments of the present disclosure relates to provide a data management system having a hierarchical structure in which management target data is not provided to a device not intended by a user as compared with a case where a highest-level device manages all entities of the management target data.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a data management system including: plural devices in a hierarchical structure, wherein a first device belonging to a hierarchy other than a lowest hierarchy of the hierarchical structure among the plural devices includes a storage unit that stores entity data of a storage target item of the first device among metadata including plural items, and an acquisition unit that acquires link information for specifying entity data of an item group other than the storage target item of the first device among the entity data of the metadata stored in a low-level device relative to the first device in the hierarchical structure.

### BRIEF DESCRIPTION OF DRAWINGS

Exemplary embodiment(s) of the present invention will be described in detail based on the following figures, wherein:

FIG. 1 is a diagram illustrating an example of a configuration of a document management system;

FIG. 2 is a diagram illustrating an example of a system configuration provided with an in-house management system;

FIG. 3 is a diagram illustrating items of metadata;

FIG. 4 is a diagram illustrating a hierarchical structure of a processing device and an MDS (metadata server) included in the document management system;

FIG. 5 is a diagram illustrating that, as a hierarchy goes up, the processing device and the MDS reduce the number of items of metadata storing entity data;

FIG. 6 is a diagram illustrating item content of metadata stored in the MDS of a certain level;

FIG. 7 is a diagram illustrating item content of metadata stored in the MDS of a level lower than a level of the example illustrated in FIG. 6;

FIG. 8 is a diagram illustrating an example of a processing sequence performed by the processing device when instructed to register a document;

FIG. 9 is a diagram illustrating an example of a processing sequence performed by the MDS when metadata is uploaded from a low-level device;

FIG. 10 is a diagram illustrating an example of a processing sequence performed by the processing device when a search request is received from a terminal of a user;

FIG. 11 is a diagram illustrating an example of a processing sequence performed by the MDS when receiving a search request from another device; and

FIG. 12 is a diagram illustrating still another example of the processing sequence performed by the MDS when receiving the search request from another device.

### DETAILED DESCRIPTION

<Examples of System to which Control According to Exemplary Embodiment is Applied>

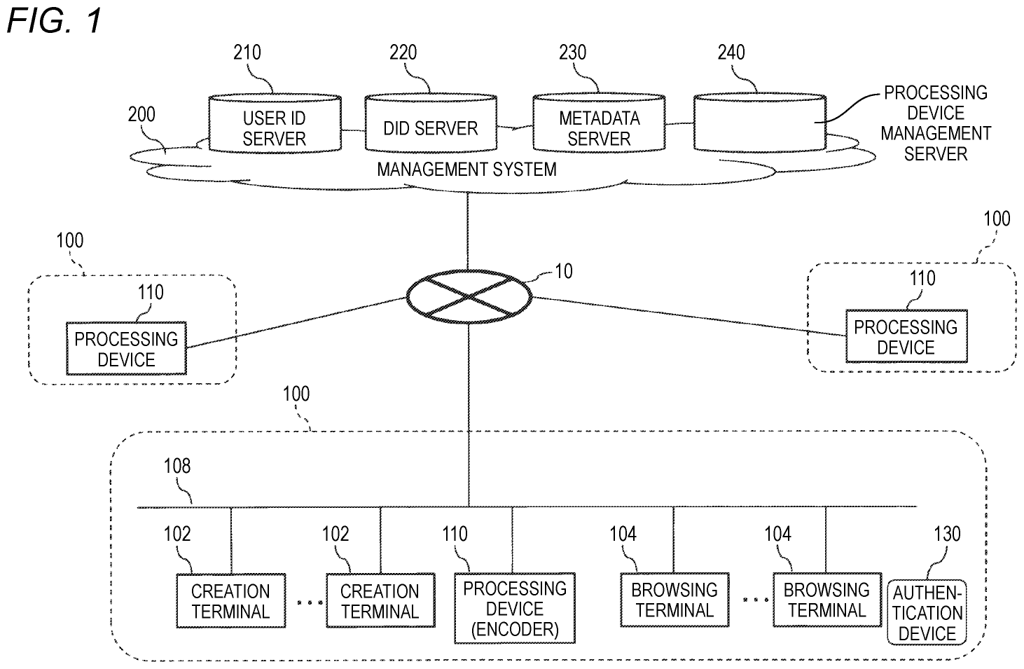

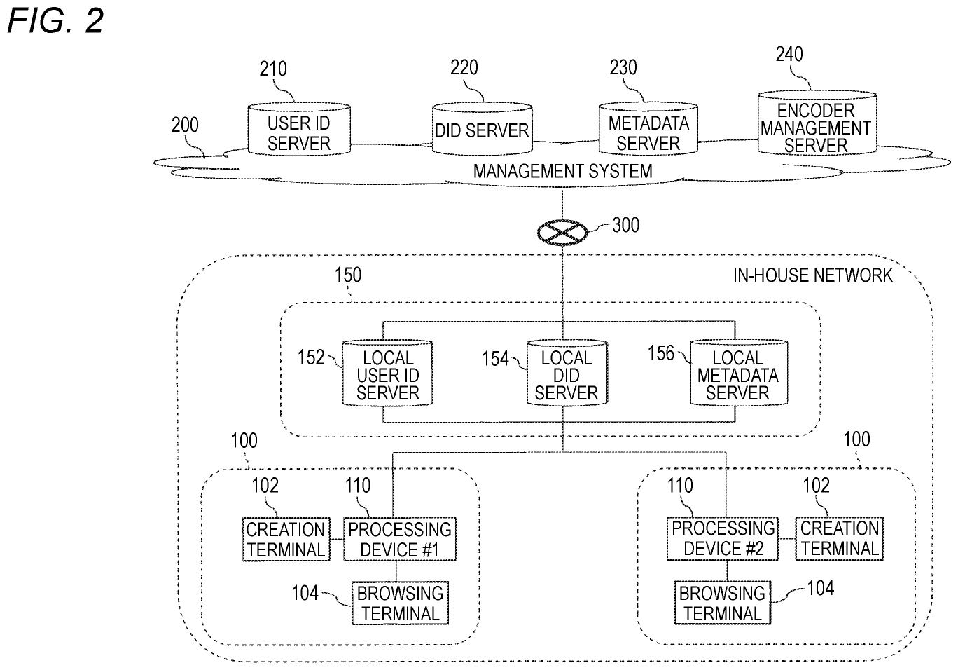

FIGS. 1 and 2 exemplify schematic configurations of document management systems to which a control according to the present exemplary embodiment is applied. The systems illustrated in FIGS. 1 and 2 are the same as the systems exemplified in JP-A-2018-156409, JP-A-2018-156410, JP-A-2018-156411, or JP-A-2018-156383, and an outline will be described herein. For details of the systems, JP-A-2018-156409, JP-A-2018-156410, JP-A-2018-156411, or JP-A-2018-156383 may be referred to.

The document management systems illustrated in FIGS. 1 and 2 is provided for offering an environment in which an electronic document is used securely, and for reducing a risk of information leakage of the document. Here, the document is content data that is distributable as one unit (for example, one file), and a type of the data is not limited in particular. For example, a concept of the document includes text data, document data created with word processor software, spreadsheet data created with spreadsheet software, computer aided design (CAD) data, image data, video data, audio data, multimedia Data, page data displayed by a web browser, and other data that is created, edited, browsed on a PC, and is targeted for printing.

The document management system illustrated in FIG. 1 includes plural local systems 100 and a management system 200 which performs management (particularly management of a processing system which will be described below) regarding the local systems. The management system 200 is configured to communicate with the respective local systems 100 via a wide area network 10 such as the Internet.

The local system 100 includes one or more creation terminals 102 connected to a local network 108, one or more browsing terminals 104, and a processing device 110. The local network 108 is a private network (for example, configured as the LAN) provided in an organization such as a company and is protected from the wide area network 10 by a firewall or the like. Basically, one processing device 110 is installed in the local system 100. When the private network in the organization is large, individual network segments that configure the private network may be the local systems 100, and one processing device 110 may be installed in each of the local systems 100.

The creation terminal 102 is used to create a document, and for example, a desktop type or notebook type personal computer, a workstation, a tablet terminal, a smartphone, a multifunction peripheral, a scanner, a facsimile machine, a digital camera, or the like is an example thereof. An application program for creating and editing a document is installed in the creation terminal 102. Software for requesting the document management system to deliver the created document is installed in the creation terminal 102. A device driver for exchanging information with the processing device 110 which will be described below, a web app, or the like may be installed as a form of the software.

The processing device 110 performs protection processing of converting a document created by the creation terminal 102 into the protected document (hereinafter, also referred to as “eDoc file”) which is a form used in a secure environment provided by the document management system. The protection processing may also be processing of encoding an original document into eDoc, and in this sense, the processing device 110 is a kind of encoder. In the protection processing, for example, the document is converted into data of a dedicated format designed for the system according to the present exemplary embodiment and is encrypted in a form that is able to be decrypted only by a user designated as a transfer destination of the document. Either the format conversion or the encryption may be performed first.

The processing device 110 creates metadata of the protected document, stores the created metadata in a built-in database in association with the protected document, and registers the metadata in the management system 200 which is a high-level system. The metadata includes a bibliographic item of the protected document, information of a delivery destination, access authority information, key information used by each delivery destination for decrypting the protected document, and the like. The bibliographic item includes, for example, items such as DID of the document, a user ID of a user (that is, a deliverer) who registered the document in the system, and date and time of registration (that is, encoding date and time). Among the items included in the metadata, data may be added or updated from a corresponding device or user depending on a function provided by the service. For example, a user who issues a document registration instruction to the document management system designates a part of the items, and the other parts are created by the processing device 110. Further, the management system 200 or the browsing terminal 104 may set a value of a part of the metadata. The processing device 110 transmits the generated protected document (eDoc file) to the browsing terminal 104 of the delivery destination designated by the user.

The metadata is an example of management target data that is a target of management according to the present exemplary embodiment.

The protected document, that is, the eDoc file, is an original document converted to a dedicated format and encrypted, and is also referred to as a body of the eDoc. Corresponding metadata is required to make the eDoc file be browsable. The eDoc file and the metadata configure a complete protected document that is browsable. As such, a set of the eDoc file and the corresponding metadata is hereinafter referred to as “eDoc”.

Each user has default processing device 110 which is previously determined. The default processing device 110 is typically installed in a department to which the user belongs. In a typical usage scenario, a user registers a document shared with the other users in his department in the processing device 110 and delivers the document to the other users. The default processing device 110 of the user is registered in a user ID server 210 in association with a user ID of the user. When the user requests the processing devices 110 other than the default processing device 110 to register the document, the processing device 110 which received the request converts the document into the protected document, generates metadata to register the metadata in the management system 200, and forwards the protected document and the metadata to the default processing device 110 of the user. The default processing device 110 stores the forwarded protected document and the metadata in the built-in database. Meanwhile, the processing device 110 of a forwarding source removes the protected document and metadata forwarded to the default processing device 110 from its own storage device. Thereby, the protected document registered by the user is stored only in the default processing device 110 of the user.

The browsing terminal 104 is used for browsing the protected document (eDoc file). As described herein, the “browsing” means that the protected document is used in a form according to information content represented by the document. For example, when the protected document has a document such as word processor data or a drawing as the information content, the browsing is that the user reads or browses the document displayed by the browsing terminal 104. When the information content represented by the protected document is voice, the browsing means that the user listens to the voice reproduced by the browsing terminal 104. The browsing terminal 104 is configured by installing a viewer application program for browsing the protected document in a general-purpose computer such as a desktop type or notebook type personal computer, a workstation, a tablet terminal, or a smartphone. A terminal, which dedicated for browsing such as an electronic book terminal, having a function equivalent to a function of a viewer application program may be used as the browsing terminal 104. The viewer application program has a function of decrypting the encrypted protected document using metadata information and a function of decoding data represented in a dedicated format of the protected document into available data. A computer that does not have a viewer application program corresponding to the document management system cannot decode data of the dedicated format into the available data.

As an example, an authentication device 130 carried by a user is used as a tool for authenticating the user who uses the document management system. The authentication device 130 is a device, such as an IC card, that incorporates identification information unique to the user who carries the device and performs data processing for user authentication in response to a request from an external device. The authentication device 130 may be a portable terminal such as a smartphone having a function equivalent to an IC card for the personal authentication. The browsing terminal 104 or the creation terminal 102 has a function of communicating with the authentication device 130 using a wireless communication protocol such as near field communication (NFC). The browsing terminal 104 or the creation terminal 102 exchanges information for user authentication with the authentication device 130 according to a predetermined protocol and authenticate a user carrying the authentication device 130. Alternatively, the actual user authentication is performed by a server of the document management system such as the processing device 110 or the management system 200, and the browsing terminal 104 or the creation terminal 102 may use a method of mediating data forwarding between the server and the authentication device 130. The browsing terminal 104 or the creation terminal 102 may incorporate the function of the authentication device 130.

The management system 200 manages the processing device 110 in each local system 100. The management system 200 manages the metadata of the protected document generated by each processing device 110 and provides the metadata to the browsing terminal 104 according to a request. The management system 200 is configured by one computer or plural computers that are configured to communicate with each other and has functions of a user ID server 210, a DID server 220, a metadata server 230, and a processing device management server 240.

The user ID server 210 manages information of each user who uses the document management system. There are two hierarchies for users using the document management system. One is a contractor who has signed a contract for using the document management system with an operator of the system, and the other is a general user who actually registers and browses the document using the system under the contract. For example, it is assumed that a company is the contractor, and the processing device 110 is installed in the local network 108 of a company, and an employee of the company uses the document management system as the general user through the processing device 110 in many cases. The user ID server 210 holds and manages information on each of the contractor and the general user.

The DID server 220 manages a document ID (DID) which is identification information (ID) of the protected document. Although the processing device 110 created the protected document actually assigns the DID to the protected document, the DID server 220 assigns an issuance authority and issuance frame (number of issues) of the DID to the processing device 110, and receives and records a report of the DID actually issued by the processing device 110 among the issuance authority and the issuance frame. Thereby, the DID server 220 may suppress occurrence of an unauthorized DID and detect a document having an incorrect DID.

The metadata server 230 holds and manages metadata of the protected document (eDoc file) generated by the processing device 110. When the metadata server 230 requests the metadata of the protected document from a user via the browsing terminal 104, the metadata server 230 provides the metadata to the browsing terminal 104 if the user is a valid person. A case where the user (browser) who requests the metadata is a “valid person” determined by the metadata server 230 is a case where a combination of the user and the browsing terminal 104 used when the user issues the request corresponds to a combination of a delivery destination user and the browsing terminal 104 of a delivery destination indicated by delivery destination information of the metadata held by the metadata server 230 in association with the DID (which is included in the request) of the eDoc file.

The processing device management server 240 manages a status (state) of each processing device 110.

A process flow of the system illustrated in FIG. 1 will be outlined.

When a user wants to register (that is, deliver) a document in the document management system, the user logs in to the creation terminal 102 using the authentication device 130 or the like and instructs the creation terminal to register a document. The user selects a document to be registered in the document management system from the documents held in the creation terminal 102 and instructs the registration.

Then, the creation terminal 102 receives an input of an item (for example, a delivery destination of the document) to be designated by the user among attribute data for the selected document. Here, a combination of the user and the browsing terminal 104 may be designated as the delivery destination. In this case, when the combination of the user and the browsing terminal 104 used by the user to browse the document matches the combination designated as the delivery destination, the user is allowed to browse the document.

The creation terminal 102 transmits the attribute data obtained by combining an attribute item such as delivery destination input by the user and other attribute items (for example, information of a registrant, creation date, and the like) created by the creation terminal 102 itself to the processing device 110 together with data of the document.

The processing device 110 generates the protected document (eDoc file) by performing protection processing for a registration target document received from the creation terminal 102. In the generation, the received document is encoded into a dedicated format of the document management system, and the encoded data is encrypted by using a generated encryption key, and thereby, the eDoc file is generated. An order of encoding and encryption may be reversed. The processing device 110 assigns a unique DID to the eDoc. The generated DID is incorporated into the eDoc file (for example, as an item of property of the file).

The processing device 110 generates metadata corresponding to the generated eDoc file. The metadata includes attribute data received from the creation terminal 102 together with a document, and values of attribute items (for example, DID, ID of the processing device itself, encoding date and time, and encryption key information) generated by the processing device 110 itself. The encryption key information included in the metadata is information indicating a key for decrypting the eDoc file. When a common key method is used for encryption, the encryption key information indicates a common key. However, if the common key itself is included in the metadata of a plain text, there is a concern that the common key may be abused by eavesdropping or interception, and thus, the common key encrypted with a public key of a delivery destination user is incorporated into the metadata as encryption key information.

The processing device 110 stores the generated eDoc file and metadata in a built-in database.

The processing device 110 transmits the generated metadata to the management system 200 and registers the metadata. The management system 200 (metadata server 230) stores the received metadata. Although details thereof will be described below, as a control specific to the present exemplary embodiment, the processing device 110 does not send entity data of all items of the generated metadata to the management system 200, band sends the entity data of only predetermined (that is, previously determined) some item groups among those are sent to the management system 200.

The processing device 110 delivers the generated eDoc file to the browsing terminal 104 designated as a delivery destination. The delivery is performed via the local network 108 in the local system 100.

Since the eDoc file received by the browsing terminal 104 is protected by encryption or the like, browsing is impossible as it is. When a user wants to browse the eDoc file in the browsing terminal 104, the user logs in to the browsing terminal 104 and then instructs browsing of the eDoc on the screen of the browsing terminal 104. The browsing terminal 104 received the instruction accesses the accessible processing device 110 or the management system 200 to request the metadata of the eDoc. The request includes a DID of the eDoc.

The processing device 110 received the request acquires a latest version of the metadata corresponding to the DID from the management system 200 and transmits the latest version to the browsing terminal 104. When the management system 200 (particularly, the metadata server 230) is configured to receive the request, the management system 200 transmits the latest version of the metadata corresponding to the DID to the browsing terminal 104. When a change (for example, a change of access authority information) is added to the metadata by an operation of a user for the processing device 110, the change is transferred to the management system 200, and the management system 200 reflects the change on the metadata thereof. Thereby, the management system 200 constantly has the latest version of the metadata of the protected document.

Here, since what is required immediately for the browsing terminal 104 received the browsing instruction of the protected document is delivery destination information, access authority information, and the like of the metadata, the processing device 110 or the management system may transmit only the access authority information to browsing terminal 104 according to the request. The delivery destination information includes, for example, a list of user IDs designated as a delivery destination of the protected document. The delivery destination information may include a list of a pair of the user ID and a terminal ID. For example, the access authority information includes information indicating content of the authority (for example, only browsing or browsing and editing are possible) of the user in association with each user ID included in the delivery destination information of the protected document.

When receiving the requested metadata, the browsing terminal 104 determines whether or not a combination of the browsing terminal 104 and a user currently using the browsing terminal 104 is included in the delivery destination information included in the metadata. If the combination is not included therein, the user does not have an authority to browse the eDoc on the browsing terminal 104, and thereby, the browsing terminal 104 does not open the eDoc file and displays an error message indicating that the user does not have the browsing authority. If the combination is included therein, the user has an authority to browse the eDoc file on the browsing terminal 104. In this case, the browsing terminal 104 decrypts the eDoc file using key information included in the metadata and outputs the eDoc file in a form according to the information content of a decryption result of the eDoc file.

After the metadata is registered in a first management system 200, the delivery destination information included in the metadata and the access authority information may be changed by a deliverer or a person (for example, a person having a data editing authority) who has an authority to change the delivery destination. Even if the user is designated in the delivery destination at a point of time when the eDoc is created and registered, when the user is excluded from the delivery destination due to a subsequent change, the browsing terminal 104 detects that by using the delivery destination information included in the latest metadata acquired from the management system 200 and does not display the eDoc file.

Although FIG. 1 illustrates a system having a hierarchical structure of two hierarchies of the processing device 110 and the management system 200, a system having three or more hierarchies may also be provided by inserting a hierarchy of a new management system. FIG. 2 exemplifies a system of three hierarchies.

In an example illustrated in FIG. 2, plural local systems 100 exist in an in-house network which is a private network of an organization such as a company. An in-house management system 150 is provided in the in-house network. The in-house management system 150 manages processing of the relevant organization in the document management system and information necessary for the processing. That is, while the management system 200 is operated by a service provider of the document management system and manages information and processing for plural organizations that use the document management system, the in-house management system 150 manages parts relating to the organization among the information and the processing under the management of the management system 200.

The in-house management system 150 includes a local user ID server 152, a local DID server 154, and a local metadata server 156.

The local user ID server 152 manages information of a user registered in the document management system among members of the organization. The information of each user held by the local user ID server 152 is the same as the information of a general user held by the user ID server 210. If a user (that is, a user who sets the processing device 110 as a “default processing device”) who acquires and uses the processing device 110 is registered in the processing device 110, the processing device 110 sends information of the registered user to the local user ID server 152 in the organization. The local user ID server 152 stores the received information of user and sends the information of user to the user ID server 210 of the central management system 200 via the wide area network 300. The user ID server 210 stores the received information of user. When a change occurs in the information of user registered in the processing device 110, an administrator or the like changes the information of user for the processing device 110. The processing device 110 transmits information (for example, a user ID, an item name of the changed information item, and a changed value of the item) of the changed content of the information of user to the local user ID server 152, and the local user ID server 152 changes the information of user stored therein according to the changed content which is received. The local user ID server 152 sends the received information of the changed content to the central user ID server 210, and the user ID server 210 changes the information of user held therein according to the sent information.

The local DID server 154 receives and stores the DID issued by the processing device 110 in each local system 100 belonging to the in-house network of the organization. Information held by the local DID server 154 is the same as the information held by the DID server 220. The local DID server 154 sends the DID information received from the processing device 110 to the central DID server 220, and the DID server 220 stores the information. The local DID server 154 is assigned an issuance authority and an issuance frame of DID from the central DID server 220, and assigns the issuance authority and the issuance frame of the DID for each processing device 110 under management based on the issuance authority within a range of the issuance frame.

The local metadata server 156 receives and stores the eDoc metadata generated by the processing device 110 in each local system 100 belonging to the in-house network of the organization. Information held by the local metadata server 156 is the same as the information held by the metadata server 230. The local metadata server 156 sends the metadata received from the processing device 110 to the central metadata server 230, and the metadata server 230 stores the metadata.

In the system illustrated in FIGS. 1 and 2 exemplified above, if values of all items of the metadata generated by the processing device 110 together with the eDoc are registered in a high-level device, that is, the in-house management system 150 or the management system 200, inconvenience may occur. For example, when confidential information limited within department in the department in which the processing device 110 is installed is included in the metadata of the eDoc, the department does not want to disclose the confidential information to the high-level in-house management system 150 or the management system 200. Likewise, when confidential item of the organization is included in the metadata, the organization does not want to disclose the confidential item to the management system 200 outside the organization.

Therefore, the present exemplary embodiment controls such that an item that a low-level device (for example, the processing device 110) wants to keep secret among items of the metadata is not registered in a high-level device (for example, the management system 200).

The document management system, particularly, a mechanism for managing metadata thereof is an example of a data management system.

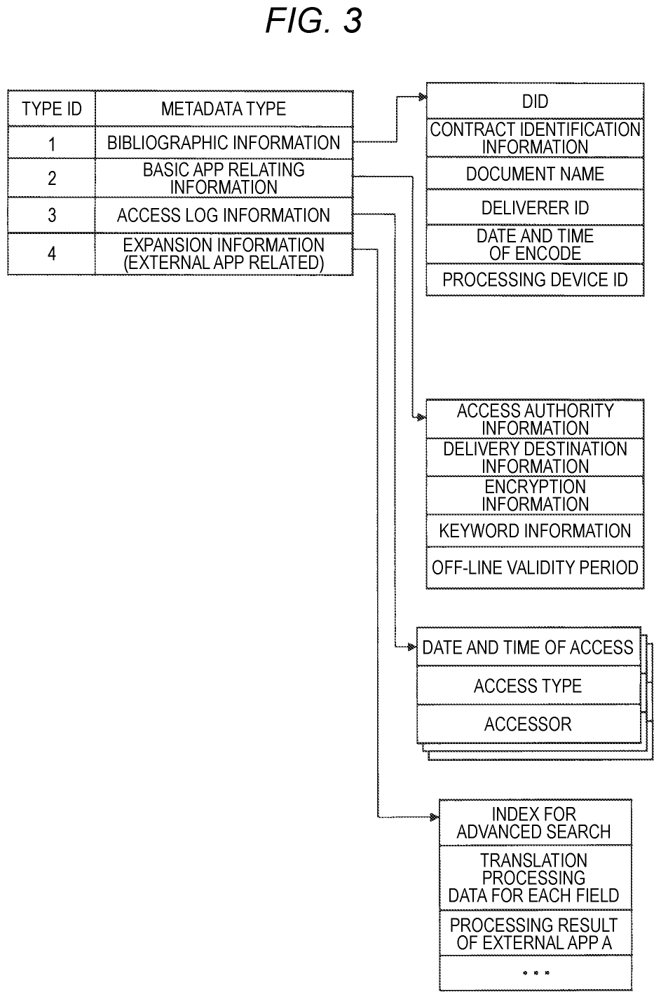

Before describing the control, an example of an item configuration of the metadata in the present exemplary embodiment will be described with reference to FIG. 3.

Item groups included in the metadata illustrated in FIG. 3 are roughly classified into four types of bibliographic information, a basic app relating information, access log information, and expansion information. The metadata of each eDoc may include the item group of the four types.

The bibliographic information indicates a bibliography on the eDoc corresponding to the metadata. The bibliographic information includes items such as a DID of eDoc corresponding to the metadata, contract identification information, a document name, a delivery ID, encoding date and time, and a processing device. The contract identification information is identification information for identifying a contract for use of the system according to the present exemplary embodiment, in which the organization which the processing device 110 generating the eDoc belongs to is coupled with an operator of the central management system 200. The document name is a file name of the eDoc. The deliverer ID is a user ID of a user who registers the eDoc in the processing device 110. The encoding date and time is date and time when the eDoc is created (that is, encoded) according to a registration instruction from the user, and the processing device ID is identification information of the processing device 110 that creates the eDoc.

The basic app relating information is used by a service (referred to as a basic app) provided by the system according to the present exemplary embodiment to the eDoc. The basic app (hereinafter, “app” is used as an abbreviation for application program) performs delivery of the eDoc, management (for example, management of availability of browsing and the like) of user access to the delivered eDoc, and the like. The basic app relating information includes, for example, items such as access authority information, delivery destination information, encryption information, keyword information, and an off-line validity period. The access authority information and the delivery destination information are previously described above. The encryption information indicates a key for decrypting the encrypted eDoc. Although the eDoc is a document which is encoded in a predetermined format and is encrypted with a certain key, the encryption information includes key information obtained by encrypting the key used for encryption with a public key of a delivery destination user, for each of the delivery destination users. The keyword information includes a search keyword (that is, search index) group of the eDoc, which is used for a simple search service provided by the system according to the present exemplary embodiment. The “simple search service” here is a term for comparison with an advanced search service that one of external apps which will be described below provides. An offline effective period is a length of a period in which the access authority information and the delivery destination information in the metadata previously acquired by the browsing terminal 104 are effective. Within the length of the offline effective period from point of time when the browsing terminal 104 acquires the metadata from the processing device 110, the in-house management system 150, or the management system 200, the browsing terminal 104 controls access of a user to the eDoc corresponding to the metadata by using the access authority information and the delivery destination information of the acquired metadata. Meanwhile, when an access such as browsing to the eDoc is requested from a user at the point of time when the offline effective period in the acquired metadata passes, the browsing terminal 104 acquires information on the latest version of the metadata from the nearest processing device 110, the in-house management system 150, or the management system 200. Then, whether or not the access relating to the request is permitted is controlled according to the information on the latest version acquired according thereto.

The access log information is log information on access from the user to the eDoc corresponding to the metadata. For example, items such as access date and time, an access type (for example, browsing, editing, and the like), and a user ID of a user (that is, item “accessor”) every time the user accesses the eDoc are added to the access log information in association with each other.

The Expansion information is an item group used by an external app among items of the metadata. A service that s person other than an operator of the system according to the present exemplary embodiment receives permission of the operator and is provided to the user via the system is an external app. The expansion information may include an item including information serving as a material of processing performed by the external app, or an item holding processing results of the external app. FIG. 3 exemplifies an advanced search index used for searching by some external apps providing the advanced search service, and translation processing data for each field which is used for translation by an external app providing translation services for each field, as an example of the former. An item for holding processing results of a certain external app A is illustrated as an example of the latter.

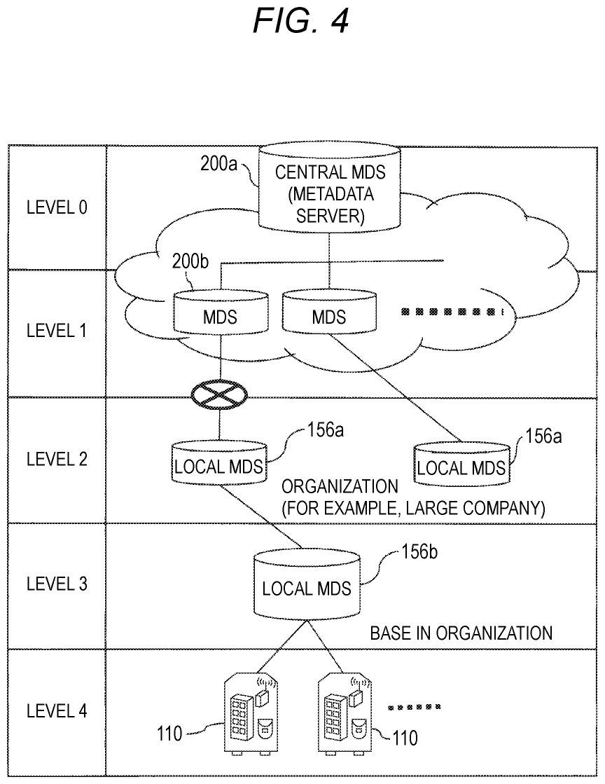

Next, an example of a hierarchical structure of the system according to the present exemplary embodiment will be described with reference to FIG. 4. FIG. 4 illustrates the hierarchical structure of the metadata server (denoted as MDS in the figure), particularly from the viewpoint of metadata management. However, a user ID server, a DID server, and the like, which are in charge of management with the MDS, exit in the same hierarchy as the MDS.

The hierarchical structure illustrated in FIG. 4 has five hierarchies of levels 0 to 4 more than the systems illustrated in FIGS. 1 and 2.

The level 0, which is the highest hierarchy, is a hierarchy of a central MDS 230a managed by an operator of the system according to the present exemplary embodiment. The central MDS 230a is the MDS unique in the world and stores metadata groups generated by all the processing devices 110 in the world. However, what the central MDS 230a stores is not all the items of the metadata but is only the items permitted to be stored in the central MDS 230a among the items. The central MDS 230a corresponds to a device of an highest hierarchy in the system.

The level 1 which is a second highest hierarchy from the top is a hierarchy to which an MDS 230b provided for each management unit such as a country or a region belongs. The MDS 230b stores a metadata group generated by the processing device 110 in each organization belonging to the management unit. However, what the MDS 230b stores is not all the items of the metadata but is only the items permitted to be stored in the MDS 230b among the items.

The level 2 which is a third hierarchy from the top is a hierarchy of a local MDS 156a installed in an organization (for example, a company) existing in a management unit such as a country or a region. The local MDS 156a is a highest-level MDS in the organization and manages the metadata for the entire organization. That is, the local MDS 156a stores a metadata group generated by the processing device 110 in the organization. However, what the local MDS 156a stores is not all items of the metadata but is only items permitted to be stored in the local MDS 156a.

The level 3 which is a fourth hierarchy from the top is the second hierarchy in the organization and includes, for example, a local MDS 156b provided for each management unit in the organization. The management unit in the organization includes, for example, a base site of the organization such as a head office, a branch office, a sales office, a factory, and a research laboratory.

In the example illustrated in FIG. 4, since the organization is large, the hierarchy of the in-house management system is configured by two hierarchies. The local MDS 156b of the management unit manages metadata of the entire management unit. That is, the local MDS 156b stores the metadata group generated by the processing device 110 in the management unit (for example, one base site in the organization). However, what the local MDS 156b stores is not all items of the metadata but is only items permitted to be stored in the local MDS 156b.

There is a service provider (or a sales company of service) that provides a service on consignment of an operator of the system according to the present exemplary embodiment, and it is considered that the service provider provides a service to a customer organization such as a small and medium-sized business. In this case, a set of the service provider and the customer organization is regarded as one organization. In this example, individual customer organization is provided with the local MDS 156b of the level 3, and the service provider is provided with the local MDS 156a of the level 2 that supervises the local MDS 156b.

The level 4 which is a lowest layer is a hierarchy to which the processing device 110 that generates and stores the metadata belongs. The processing device 110 basically stores all items of the metadata generated by the processing device itself. However, it is also possible for a predetermined item group of the items of the metadata to be set so as not to be stored in the processing device 110. The processing device 110 corresponds to the lowest hierarchy device in the system.

The devices in each hierarchy store address information of the direct high-level device of the device itself in the hierarchical structure. For example, the processing device 110 has address information of the local MDS 156b (or the in-house management system of level 3 including the same) of level 3 which is a higher level than the device itself in the hierarchical structure. For example, the local MDS 156b has address information of the local MDS 156b (or an in-house management system of level 2 including the same) of level 2, which is higher level than the device itself in the hierarchical structure. When communicating with a high-level device, such as when uploading the metadata to a high-level device using the address information of the high-level device, the device of each hierarchy uses the address information.

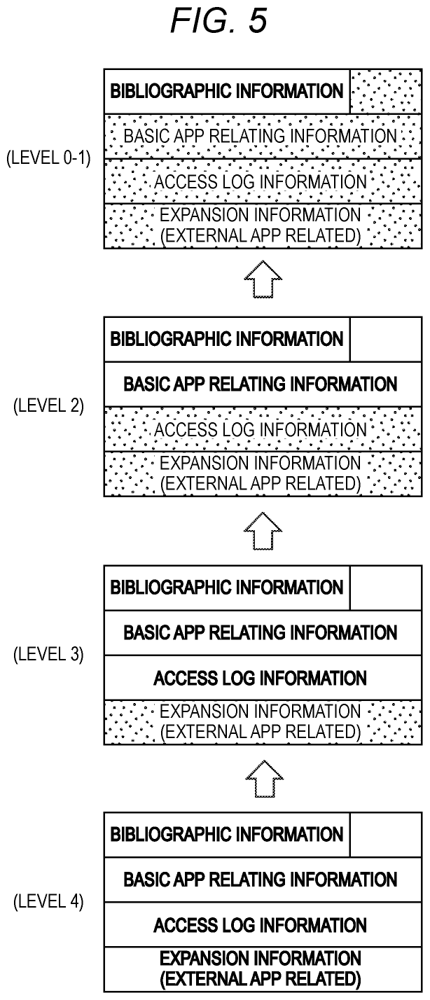

Next, an example of a storage configuration in which entity data of a certain item of the metadata item group is stored in the device of each level in FIG. 4 will be described with reference to FIG. 5.

A basic idea of the storage configuration is that the higher the hierarchy or the level, the fewer the items in which the entity data is stored by the device of the hierarchy. The example illustrated in FIG. 5 is an example of a case where, among types of the metadata item groups illustrated in FIG. 3, the higher the type ID number, the higher a degree of secrecy for a user (that is, an organization, a base site within the organization, or a department).

Here, the “entity data” of the item of the metadata is a substantive value of the item among the metadata. In contrast to this, link information which will be described below is information indicating entity data of the item.

Since the processing device 110 of level 4 which is the lowest layer is a device that generates and stores metadata and an eDoc body corresponding to the metadata, the processing device basically stores all items of the metadata. In the example illustrated in FIG. 5, the processing device 110 of level 4 stores all items belonging to four types of bibliographic information, a basic app relating information, access log information, and expansion information. In FIG. 5, the types of metadata items stored by the device of each level are illustrated in bold.

In the example illustrated in FIG. 5, the local MDS 156b of level 3 stores item groups belonging to the bibliographic information, the basic app relating information, and the access log information but does not store an item group belonging to the expansion information. This example corresponds to a case where the item group belonging to the expansion information is secret outside a department where the processing device 110 is installed.

In the example illustrated in FIG. 5, the local MDS 156a of level 2 stores item groups belonging to the bibliographic information and the basic app relating information but does not store item groups belonging to the access log information and the expansion information. This example corresponds to a case where the item group belonging to the access log information is secret outside a base site where the local MDS 156a is installed.

The MDS 230b of level 1 and the central MDS 230a of level 0 outside the organization store partial item groups of the bibliographic information but do not store item groups belonging to the rest of the bibliographic information, the basic app relating information, the access log information, and the expansion information. This example corresponds to a case where partial items of the bibliographic information and the item groups belonging to the basic app relating information are secret outside the organization.

In the example illustrated in FIG. 5 described above, types of the metadata items to be stored decrease by the MDS of a high-level hierarchy, generally based on the types of the metadata items. However, using the type as a unit is only an example. The item the MDS of each hierarchy stores may be defined in item units. For example, the central MDS 230a and the MDS 230b belonging to levels 0 and 1 may be basically controlled in the item units, such as not storing the items belonging to the type of basic app relating information, but storing two items of access authority information and delivery destination information among the items.

As exemplified in FIG. 5, a storage configuration in which less items of the metadata about which the device stores the entity data are stored in the device in a higher hierarchy is called metadata escalation.

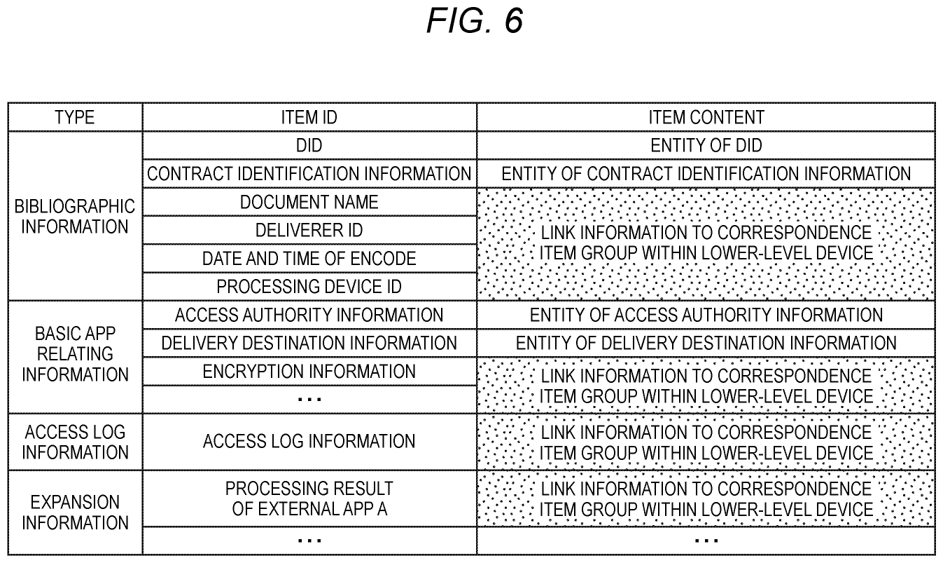

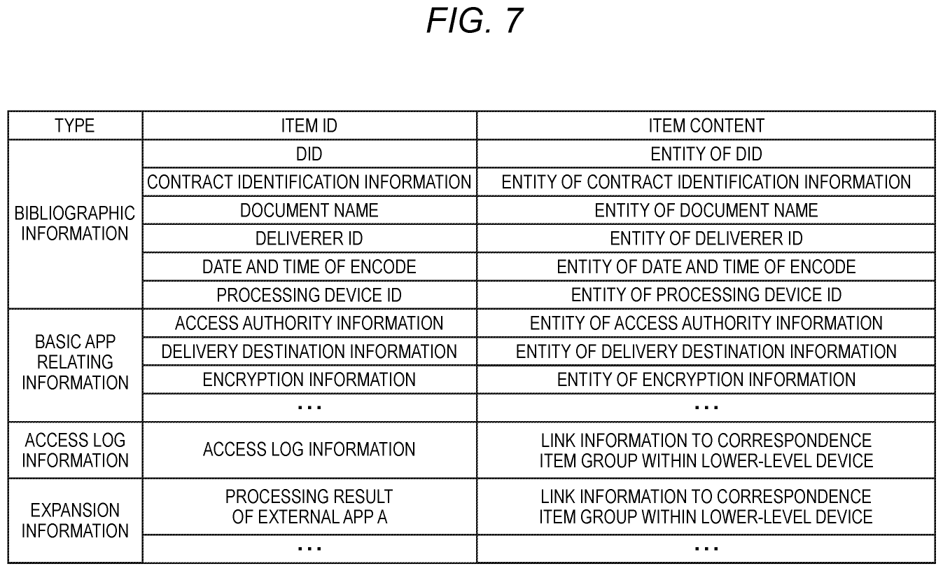

Next, data content of the metadata that the MDS of several levels (that is, hierarchy) stores will be described with reference to FIGS. 6 and 7.

FIG. 6 is a diagram illustrating the data content of the metadata stored in the MDS 230b of level 1. In the figure, an “item ID” is an ID (that is, identification information) of each item included in the metadata of one eDoc. In the illustrated example, names of the respective items are illustrated in a field of the item ID for the sake of easy understanding. A “type” indicates the type to which each item belongs. An “item content” is data content of the item stored in the MDS 230b.

In the example illustrated in FIG. 6, the MDS 230b stores entity data of the items for the items “DID” and “contract identification information” belonging to a type of the bibliographic information, and for the items “access authority information” and “encryption information” belonging to the type of the basic app relating information. For example, the MDS 230b stores an actual DID value for the DID and an actual contract identification information value for the contract identification information. An item in which entity data is stored in content of the item is an item of a storage target for the MDS.

In contrast, the MDS 230b stores link information as the item content instead of the entity data of the item with regard to the remaining items of the bibliographic information except the DID and the contract identification information. The item link information specifies the entity data of the item, as a whole. In this example, the item link information is stored in a low-level device (that is, the MDS or the processing device) located immediately below the MDS in the hierarchical structure and indicates the item content of the item. Here, in the hierarchical structure of the MDS and the processing device configured in a tree shape, a “low-level device” of a certain MDS is a device corresponding to a child node of the MDS in the hierarchical structure. For example, the link information which is item content of a certain item in a certain metadata included in the MDS 230b indicates the item content of the item of the metadata in the MDS 230b including the metadata in a group of the local MDS 156a of level 2 which is a child of the MDS 230b. If the item content of the low-level device indicated by the link information is entity data of the item, the item content may be the link information furthermore. Also in the latter case, it is possible to finally acquire entity data of the item by following the link information of indication destination of the link information, link information that this indicates points, and link information in a chained manner. In this sense, the link information in the illustrated example is also information for specifying the entity data of the item.

For example, the link information includes information indicating a location of the low-level device on the network, and information identifying the item in the metadata stored in the low-level device. Here, the information identifying the item in the metadata may be a combination of metadata identification information and item identification information. For example, DID of eDoc corresponding to the metadata is used for the metadata identification information. The item identification information uniquely identifies individual items such as the DID, the contract identification information, the document name, and the user ID. In this example, a specific item within the specified metadata is identified by the combination of the metadata identification information and the item identification information.

In the specific example, the link information is described in a form of a uniform resource identifier (URI) or a uniform resource locator (URL). When a host name of the local MDS 156a that is a low-level device of a certain MDS 230b is, for example, “eduser.sample.com”, the link information which is the item content of an item “yyyy” in the metadata of the eDoc whose DID is “xxxx” in the MDS 230b becomes, for example, “data://eduser.sample.com/intApr?DID=xxx&AprID=yyyy”.

A description format of the link information is not limited to the URI or the URL. For example, when the same content as the URL illustrated above is described as a query of SQL, “SELECT “DID”, “did” FROM “metadata3” WHERE “AprID”, “xxx”” is obtained, and the MDS 230b sends the query to the low-level device by referring to the link information, and thus, the item content of the item of the metadata is acquired.

The link information may be item unit or group unit configured by plural items. In the example illustrated in FIG. 6, link information indicating the group in the low-level device is described for the group of four items from a document name belonging to the bibliographic information to a processing device ID.

The example illustrated in FIG. 7 is a diagram illustrating data content of the metadata stored in the local MDS 156a of level 2. When compared to the metadata (see FIG. 6) stored in the MDS 230a of level 1, the metadata stored in the local MDS 156a is different from the metadata in that four items from a document name to a processing device ID in the bibliographic information include entity data. Although the item content of the access log information is the link information, this link information indicates item content of the access log information of the metadata in the local MDS 156b of level 3 which is the low-level device.

Thus, in the system according to the present exemplary embodiment, in order to realize the storage configuration between the hierarchies as illustrated in FIG. 5, each device such as the processing device 110, the local MDSs 156, 156a, and 156b, and the MDS 230b has metadata management information indicating an item to be uploaded (that is, transmitted) to a high-level device (that is, the device corresponding to a parent node of the processing device 110 in the tree-shaped hierarchical structure) among the items. That is, an item not indicated as the item to be uploaded in the metadata management information is an item for which the entity data has to be kept secret for the high-level device. Each device uploads the entity data of the item indicated in the metadata management information among the stored metadata to a high-level device relative to the device.

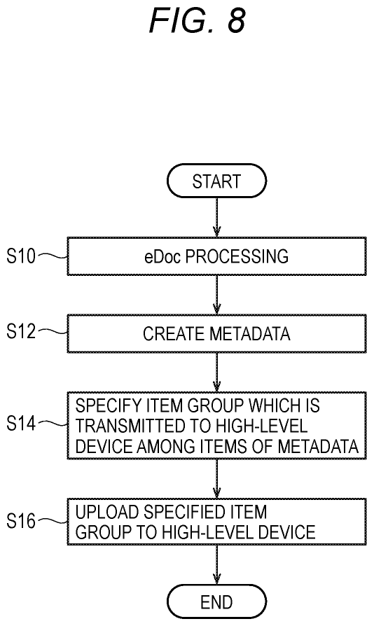

Next, an example of a processing sequence that the processing device 110 performs when receiving a document registration request from the creation terminal 102 of a user will be described with reference to FIG. 8.

In the sequence, the processing device 110 first performs eDoc processing of a document (S10). That is, for example, an eDoc file is generated by encoding the document into a dedicated format of the present system and encrypting the encoded result. The processing device 110 generates metadata of the eDoc and stores entity data thereof as an item value for the item of which the entity data is able to be acquired among the metadata (S12). Next, the processing device 110 specifies an item for uploading entity data to the local MDS 156b of a high-level of the processing device 110 in the hierarchical structure among the respective items of the metadata created and stored earlier by referring to the metadata management information that the processing device 110 itself includes (S14). Then, the processing device uploads entity data of a specific item among the created metadata to the local MDS 156b in association with metadata identification information and item identification information (S16).

The entity data of the item not uploaded among the items of the created metadata is stored only in the processing device 110 in the entire system according to the present exemplary embodiment.

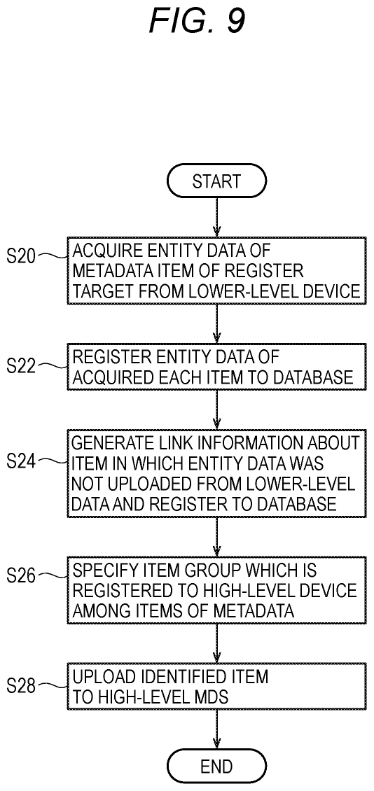

Next, an example of a processing sequence of the device to which the metadata is uploaded from a low-level device will be described with reference to FIG. 9. The device that performs the processing sequence is the remaining device in the hierarchical structure except for the lowest-level (that is, processing device 110) and the highest-level (that is, central MDS 230a), that is, the local MDSs 156a and 156b and the MDS 230a.

In the sequence, the device receives uploading of the metadata to be registered from a low-level device and acquires entity data of each item included in the metadata (S20). Next, the device registers the uploaded metadata in the built-in database (S22). In S22, the device creates an entry for the uploaded metadata in the database, and registers the entity data of the item included in the uploaded metadata for each item of the entry (S24).

The device generates link information on the item in which the entity data is not uploaded from the low-level device and registers the link information in the database as item content of the item of the metadata (S26). A host name of the low-level device is known by communication for uploading, and the DID for identifying the metadata is included in the uploaded data. The link information may be generated from the above information and the information of the item to which the entity data is not uploaded.

Next, the device specifies an item to upload the entity data to a high-level device of the device in the hierarchical structure, among the respective items of the metadata uploaded from the low-level device by referring to the metadata management information that the device itself includes (S26). Then, entity data of a specific item is uploaded to the high-level device in association with the metadata identification information and the item identification information (S28).

Escalation of the metadata illustrated in FIG. 5 is realized when the processing device 110, the local MDSs 156a and 156b, and the MDS 230a configuring the hierarchical structure perform the processing illustrated in FIG. 8 or FIG. 9, respectively.

In the sequence illustrated in FIG. 9, the MDS that receives the uploading of the entity data of each item of the metadata from the low-level device creates link information for the item for which the entity data is not uploaded. As another example, the low-level device may generate link information for an item or an item group for which entity data is not uploaded to the high-level MDS and may upload the generated link information to the high-level MDS together with the entity data. In this case, the MDS may store the entity data and the link information of each item uploaded from the low-level device in a built-in database.

Next, search processing of metadata of the system according to the present exemplary embodiment will be described.

The processing device 110 receives a search request of the metadata from a terminal (for example, the browsing terminal 104) of a user. The search request includes a search condition. The search condition is a condition that the metadata desired by the user is satisfied. In one example, the search condition is represented as a logic expression of a condition that each item included in the metadata desired by the user is satisfied. For example, when the user wants the metadata of a specified eDoc, the search condition includes a value of the DID of the eDoc as a value of the item “DID” of the metadata. The search request may include search item information designating one or more items to be obtained as a search result in addition to the search condition. There is a case where the user wants to obtain the entire metadata as a search result, or a case where the user wants to obtain only one or more specific items in the metadata. For example, a list of item IDs of items that the user wants to obtain (that is, items to be searched) becomes the search item information.

The processing device 110 has a function of forwarding a search request to the local MDS 156b which is a high-level device of the device itself in the hierarchy of level 3 when receiving the search request from a terminal of a user. For example, when the processing device 110 does not store the metadata including the DID indicated in the search request designated by the user, the metadata is the metadata of eDoc created by another processing device 110, and thereby, the search request is forwarded to a high-level.

The local MDS 156b that receives forwarding of the search request from the low-level processing device 110 checks whether or not the metadata satisfying the search condition of the search request is in a database built in the device, and forwards the search request to the high-level local MDS 156a of the device if the metadata is not in the database.

When metadata satisfying the search condition of the search request is in the database built in the local MDS 156b, the local MDS 156b provides the metadata to the terminal of the user who issues the search request via the processing device 110 of a forwarding source or directly. In the latter case, the local MDS 156b responds to the processing device 110 with the metadata, and the processing device 110 receiving this transmits the metadata to the terminal of the request source. In the latter case, the search request includes address information of the terminal of the user which is the request source, and the local MDS 156b transmits the metadata to the terminal using the address information.

Here, even when the metadata satisfying the search condition in the search request is present in the database of the local MDS 156b, there may be a case where there is no entity data of partial items of the metadata. In this case, the database includes link information instead of the entity data as item content of the item. The local MDS 156b uses the link information to perform a control such that the entity data of the item is provided to the terminal of the user who issues the search request.

In this control, the local MDS 156b uses the link information to issue, for example, a request for data indicated (that is, a link destination of the link information) by the link information. The request is sent to the low-level processing device 110 indicated by the link information. The low-level processing device 110 includes entity data of the item indicated by the link information and returns the entity data to the local MDS 156b. The local MDS 156b provides the returned entity data to the terminal of the user of the search request source via the processing device 110 (that is, the device receiving the search request from the user) of the forwarding source of the search request or directly.

In another example of the control, the local MDS 156b forwards the search request to the low-level processing device 110 indicated by the link information. The low-level processing device 110 receiving the forwarded search request provides the entity data of each item, which is indicated by the search item information, of the management data satisfying the search condition of the search request to the terminal of the user of the search request source directly or via the local MDS 156 of the forwarding source.

The high-level local MDS 156a of level 2 that receives the search request forwarded from the local MDS 156 of level 3 checks whether or not the metadata satisfying the search condition of the search request is in the database built in the MDS, and forwards the search request to the high-level MDS 230b of the MDS in the hierarchy of level 2 if the metadata is not in the database. When the metadata satisfying the search condition is in database built in the MDS, if the entity data of the item desired by the user indicated by the search item information is in the database, the entity data of the item is provided to the terminal of the user of the search request source directly or via the local MDS 156b of the forwarding source. In other words, the latter forwards the metadata to the terminal of the user by reversing a route to which the search request is forwarded. Even when the metadata satisfying the search condition of the forwarded search request is in the database built in the local MDS 156a, the local MDS 156a performs a control for providing the entity data of the item to the terminal of the user who issues the search request, using the link information corresponding to the item when the entity data of the item desired by the user indicated by the search item information is not in the database. This control may be the same as a case of the local MDS 156b of level 3.

As described above, the MDS of each level forwards a search request to a high-level device or a low-level device to obtain a search result according to the search request.

In the following, an example of a sequence performed by the processing device 110, the local MDSs 156a and 156b, and the MDSs 230a and 200b for searching will be described. Hereinafter, a case where DID is designated as a search condition is taken as an example.

For example, when a user requests the browsing terminal 104 to browse a certain eDoc stored in the browsing terminal 104 or instructs synchronization of metadata for the eDoc, the browsing terminal 104 requests a latest version of the metadata to the accessible processing device 110. This request includes DID as information specifying the eDoc. Accordingly, this request is an example of a search request in which DID is designated as a search condition.

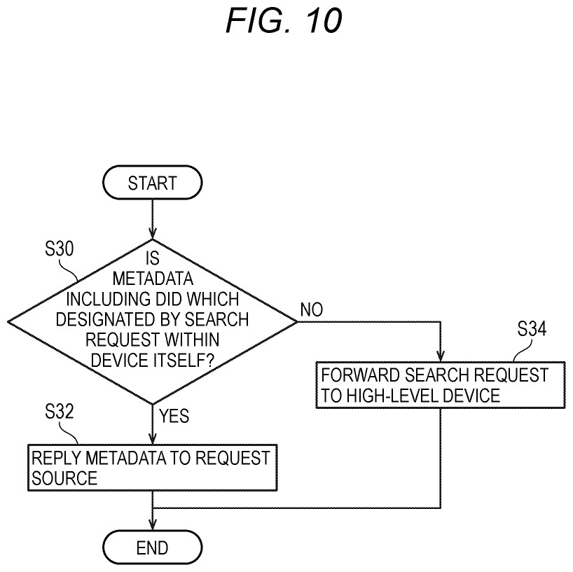

FIG. 10 illustrates an example of a processing sequence performed by the processing device 110 received a search request. In the sequence, the processing device 110 received the search request reads a value of DID indicated by a search condition of the search request and searches the built-in database for metadata having the value as item content of the item “DID”. Then, the processing device determines whether or not the metadata satisfying the search condition is searched from the database (S30). If the metadata is searched, the processing device 110 responds to the browsing terminal 104 of a request source on the metadata that is searched (S32). Basically, since entity data of all items of the metadata is stored in a database of the processing device 110, the entity data of all items of the metadata may be provided to the processing device 110.

When the determination result in S30 is No, the processing device 110 does not store the metadata having the DID which is the search condition of the search request. The metadata is metadata of eDoc generated by another processing device 110. In this case, the processing device 110 forwards the search request to a high-level local MDS 156b in the hierarchical structure (S34).

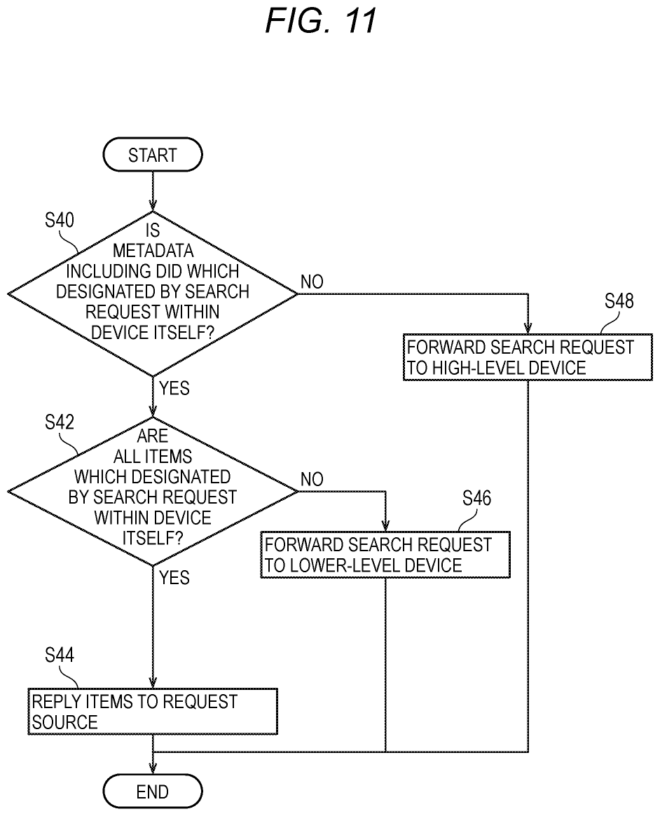

In the example, the local MDS 156b received the search request forwarded from the processing device 110 performs a processing sequence illustrated in FIG. 11. The local MDS 156a of level 2, the MDS 230b of level 1, and the MDS 230a of level 0 also perform the same processing sequence. Hereinafter, the processing sequence illustrated in FIG. 11 will be described below. In the following description, the local MDS 156b, the local MDS 156a, the MDS 230b, and the MDS 230a will be collectively referred to as an “MDS”.

In the sequence illustrated in FIG. 11, the MDS received the search request forwarded from a low-level device reads a value of DID indicated by a search condition of a search request and searches the built-in database for metadata having the value as item content of the item “DID”. Then, the MDS determines whether or not the metadata satisfying the search condition is searched from the database (S40). If the metadata is searched, the MDS determines whether or not the metadata in the database includes entity data of all items of a search target indicated by search item information of the search request (S42). If the determination result in S42 is Yes, the MDS responds to the browsing terminal 104 of a request source on the entity data of the search target item of the searched metadata (S44). The response may be made directly by the MDS or may be reversed depending on a search request forwarding path.

When the determination result in S42 is No, the MDS has link information for an item for which the MDS does not have the entity data among the items of a search target. The MDS forwards the search request to the low-level device indicated by the link information (S46).

When the determination result in S40 is No, the MDS forwards the search request to a high-level device (S48).

When the device received the search request forwarded from the MDS in S46 is the processing device 110, the processing device 110 will have entity data of all items of the metadata that is the target of the search request. Therefore, the processing device 110 responds to the browsing terminal 104 of a request source directly or by reversing a forwarding path of the search request, on the entity data of the item of a search target among the metadata.

When the device received the search request forwarded from the MDS in S46 is another MDS, the corresponding MDS performs the processing illustrated in FIG. 11. However, in this case, since the corresponding MDS will have the entity data of all items of the metadata that is a target of the search request, the processing of S40 and S48 is unnecessary.

When the device received the search request from the MDS in S48 is another MDS, the corresponding MDS performs the processing illustrated in FIG. 11.

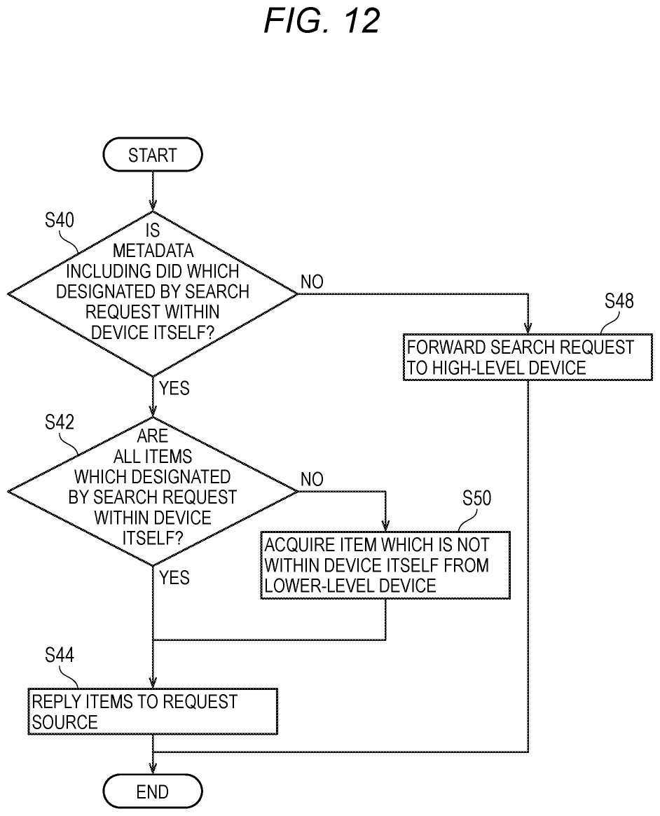

Another example of the processing sequence performed by the MDS received the forwarded search request will be described with reference to FIG. 12. In the sequence illustrated in FIG. 12, the same step as in the sequence illustrated in FIG. 11 will be denoted by the same reference numeral.

In the sequence illustrated in FIG. 12, when the determination result in S42 is No, the MDS acquires entity data of an item that the MDS itself (hereinafter, referred to as a “focused MDS”) does not have among the items of a search target, from a low-level device (S50). That is, in this case, since the focused MDS has link information on an item that the MDS itself does not have, the focused MDS requests the entity data for the item to the low-level device using the link information. If the low-level device received the request has the entity data of the item, the device responds to the high-level MDS of a request source on the entity data, and if the device does not have the entity data, the device requests entity data of the item from an additional low-level device using the link information included in the low-level device. As such, by propagating the request to the low-level device using the link information, finally the entity data of the item reaches, and the entity data is brought to the focused MDS through a reverse path of the propagation path. As such, the focused MDS obtains the entity data of the item of the metadata requiring the search request. Then, the MDS responds to the browsing terminal 104 of a user of the request source directly or by reversing the path to which the search request acquired in S40 is forwarded, on the entity data of the items (S44).

As described above, the document management system is configured with plural processing devices 110 and plural devices having a hierarchical structure of MDS at each level.

Here, the processing device 110 and the MDS each have a database for storing metadata of each eDoc. The database is an example of a storage unit. The MDS has a function of acquiring link information in metadata necessary for search and the like from a database built in the MDS itself, and the function is an example of an acquisition unit. The MDS has a function of receiving entity data of a metadata item group transmitted from a low-level device (that is, the processing device 110 or a low-level MDS) in a hierarchical structure, and the function is an example of a reception unit. The processing device 110 and the MDS hold information for defining an item whose entity data will be transmitted to a high-level device among the metadata item groups and transmit the entity data of the item defined in the information among the metadata received from the low-level device to the high-level device. The transmission function is an example of a transmission unit.

The MDS has a function of associating the entity data of the metadata item group received from the low-level device and the link information for the item whose entity data is not received with the metadata identification information (that is, DID) to store in the database. The function is an example of a storage control unit. The function may include a function of generating the link information from the metadata information received from the low-level device.

The MDS also has a function of receiving a search request from a terminal of a user or another device (that is, the processing device 110 or another MDS), and the function is an example of a unit that receives a search request. As exemplified in S46, S48, and S50 illustrated in FIGS. 11 and 12, the MDS has a function of forwarding the search request received from another device to the high-level or low-level device, and the function is an example of a search control unit.

As described above, although exemplary embodiments of the present invention are described, the exemplary embodiments illustrated above are only illustrative examples.

In the above-described exemplary embodiments, the link information (for example, see FIG. 6) of an item (or a group of items) in the metadata included in the MDS indicates item content of the item (or the group of items) in the low-level device of the MDS, and the item content may be link information. In contrast to this, as another example, the link information of the metadata included in the MDS may have the entire metadata as a unit not for each item or each group. The link information in this case includes information (for example, address information) specifying a low-level device storing the metadata, and DID functioning as metadata identification information.

As yet another example, the link information for the item or group of the metadata included in the MDS may indicate the entity data of the item or group stored in any of the device groups of a descendant of the MDS in a hierarchical structure instead of indicating information in a low-level device (that is, a device of a child in a tree-shaped hierarchical structure) of the metadata. For example, link information of certain metadata included in the MDS may indicate the metadata (or entity data of each item of the metadata) in the processing device 110 which is a descendant of the MDS and has entity data of all items of the metadata.

In the above-described exemplary embodiment, the MDS of each level stores link information, but the link information may be stored in an external device of the system according to the present exemplary embodiment. The external device stores link information for specifying entity data of metadata in association with a DID functioning as metadata identification information. The link information may be, for example, information (for example, a URL) for specifying the metadata in any one of the processing devices 110. Alternatively, the external device may store the link information for specifying entity data of an item, for each item of the metadata in association with the DID. When the metadata corresponding to the DID indicated in a search condition of a search request is not stored, the MDS of each level or the processing device 110 acquires link information corresponding to the DID from the external device. That is, the MDS has an acquisition unit for acquiring the link information from the external device. Then, the MDS acquires the entity data of the metadata corresponding to the DID using the link information and provides the acquired entity data to the browsing terminal 104 of a user of a request source directly or via a forwarding path of a search request in a reverse direction.

The respective devices such as the creation terminal 102, the browsing terminal 104, the processing devices 110, 1105, and 110R, the local user ID server 152, the local DID server 154, the local metadata servers 156, 156a, and 156b, the user ID server 210, the DID server 220, the metadata servers 230, 230a, and 230b, and the processing device management server 240, which are exemplified above, are realized by causing a computer to execute a program representing functions of the respective devices described above. Here, the computer Have a circuit configuration in which, for example, a microprocessor such as a CPU, a memory (primary storage) such as a random access memory (RAM) or a read only memory (ROM), a flash memory or a solid state drive (SSD), a controller that controls a fixed storage device such as a hard disk drive (HDD), various input/output (I/O) interfaces, a network interface that controls s connection to a network such as a local area network, and the like are connected to each other, as hardware. A program in which processing content of the respective functions is described is stored in a fixed storage device such as a flash memory via the network or the like and is installed in the computer. The program stored in the fixed storage device is read out to the RAM and executed by the microprocessor such as the CPU, and thereby, the functional module group exemplified above is realized.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A data management system comprising:
a plurality of devices in a hierarchical structure,
wherein a first device belonging to a hierarchy other than a lowest hierarchy of the hierarchical structure among the plurality of devices includes
a storage unit that stores entity data of a storage target item of the first device among metadata including a plurality of items, and
an acquisition unit that acquires link information for specifying entity data of an item group other than the storage target item of the first device among the entity data of the metadata stored in a low-level device relative to the first device in the hierarchical structure.

2. The data management system according to claim 1,
wherein a second device belonging to a hierarchy other than the lowest hierarchy and a highest hierarchy of the hierarchical structure among the plurality of devices includes
a first reception unit that receives entity data of the storage target item from a low-level device relative to the second device,
a first transmission unit that transmits entity data of a predetermined item among entity data of the received storage target item to a high-level device relative to the second device in the hierarchical structure, and
a storage control unit that controls storage of the entity data of the storage target item received by the first reception unit in the storage unit in association with the link information.

3. The data management system according to claim 2,
wherein the storage control unit generates the link information from information of the low-level device obtained when the first reception unit receives the entity data of the storage target item, and stores the generated link information and the entity data of the storage target item received by the first reception unit, in the storage unit.

4. The data management system according to claim 1,
wherein a third device belonging to the lowest hierarchy in the hierarchical structure includes
a generation unit that generates the metadata based on processing performed by the third device, and
a second transmission unit that transmits entity data of a predetermined item among the metadata generated to a high-level device relative to the third device in the hierarchical structure.

5. The data management system according to claim 2,
wherein a third device belonging to the lowest hierarchy in the hierarchical structure includes
a generation unit that generates the metadata based on processing performed by the third device, and
a second transmission unit that transmits entity data of a predetermined item among the metadata generated to a high-level device relative to the third device in the hierarchical structure.

6. The data management system according to claim 3,
wherein a third device belonging to the lowest hierarchy in the hierarchical structure includes
a generation unit that generates the metadata based on processing performed by the third device, and
a second transmission unit that transmits entity data of a predetermined item among the metadata generated to a high-level device relative to the third device in the hierarchical structure.

7. The data management system according to claim 1,
wherein a fourth device among the plurality of devices includes
a second reception unit that receives a search request for the metadata, and
a search control unit that performs a control to search for the metadata satisfying the search request, and that is configured to forward the search request to at least one of a low-level device or a high-level device relative to the fourth device in the hierarchical structure.

8. The data management system according to claim 2,
wherein a fourth device among the plurality of devices includes
a second reception unit that receives a search request for the metadata, and
a search control unit that performs a control to search for the metadata satisfying the search request, and that is configured to forward the search request to at least one of a low-level device or a high-level device relative to the fourth device in the hierarchical structure.

9. The data management system according to claim 3,
wherein a fourth device among the plurality of devices includes
a second reception unit that receives a search request for the metadata, and
a search control unit that performs a control to search for the metadata satisfying the search request, and that is configured to forward the search request to at least one of a low-level device or a high-level device relative to the fourth device in the hierarchical structure.

10. The data management system according to claim 4,
wherein a fourth device among the plurality of devices includes
a second reception unit that receives a search request for the metadata, and
a search control unit that performs a control to search for the metadata satisfying the search request, and that is configured to forward the search request to at least one of a low-level device or a high-level device relative to the fourth device in the hierarchical structure.

11. The data management system according to claim 5,
wherein a fourth device among the plurality of devices includes
a second reception unit that receives a search request for the metadata, and
a search control unit that performs a control to search for the metadata satisfying the search request, and that is configured to forward the search request to at least one of a low-level device or a high-level device relative to the fourth device in the hierarchical structure.

12. The data management system according to claim 6,
wherein a fourth device among the plurality of devices includes
a second reception unit that receives a search request for the metadata, and
a search control unit that performs a control to search for the metadata satisfying the search request, and that is configured to forward the search request to at least one of a low-level device or a high-level device relative to the fourth device in the hierarchical structure.

13. The data management system according to claim 7,
wherein in the fourth device of each hierarchy in the hierarchical structure in which entity data of a part or all item of the metadata that is common is stored in the storage unit, identification information of the metadata is stored in the storage unit, and
wherein, in a case where the search request is a request to obtain the metadata having a specific identification information, the search control unit forwards the search request to the high-level device relative to the fourth device in the hierarchical structure in a case where the specific identification information is not stored in the storage unit, and the search control unit does not forward the search request to the high-level device relative to the fourth device in the hierarchical structure in a case where the specific identification information is stored in the storage unit.

14. The data management system according to claim 8,
wherein in the fourth device of each hierarchy in the hierarchical structure in which entity data of a part or all item of the metadata that is common is stored in the storage unit, identification information of the metadata is stored in the storage unit, and
wherein, in a case where the search request is a request to obtain the metadata having a specific identification information, the search control unit forwards the search request to the high-level device relative to the fourth device in the hierarchical structure in a case where the specific identification information is not stored in the storage unit, and the search control unit does not forward the search request to the high-level device relative to the fourth device in the hierarchical structure in a case where the specific identification information is stored in the storage unit.

15. The data management system according to claim 9,
wherein in the fourth device of each hierarchy in the hierarchical structure in which entity data of a part or all item of the metadata that is common is stored in the storage unit, identification information of the metadata is stored in the storage unit, and
wherein, in a case where the search request is a request to obtain the metadata having a specific identification information, the search control unit forwards the search request to the high-level device relative to the fourth device in the hierarchical structure in a case where the specific identification information is not stored in the storage unit, and the search control unit does not forward the search request to the high-level device relative to the fourth device in the hierarchical structure in a case where the specific identification information is stored in the storage unit.

16. The data management system according to claim 10,
wherein in the fourth device of each hierarchy in the hierarchical structure in which entity data of a part or all item of the metadata that is common is stored in the storage unit, identification information of the metadata is stored in the storage unit, and
wherein, in a case where the search request is a request to obtain the metadata having a specific identification information, the search control unit forwards the search request to the high-level device relative to the fourth device in the hierarchical structure in a case where the specific identification information is not stored in the storage unit, and the search control unit does not forward the search request to the high-level device relative to the fourth device in the hierarchical structure in a case where the specific identification information is stored in the storage unit.

17. The data management system according to claim 11,
wherein in the fourth device of each hierarchy in the hierarchical structure in which entity data of a part or all item of the metadata that is common is stored in the storage unit, identification information of the metadata is stored in the storage unit, and
wherein, in a case where the search request is a request to obtain the metadata having a specific identification information, the search control unit forwards the search request to the high-level device relative to the fourth device in the hierarchical structure in a case where the specific identification information is not stored in the storage unit, and the search control unit does not forward the search request to the high-level device relative to the fourth device in the hierarchical structure in a case where the specific identification information is stored in the storage unit.

18. The data management system according to claim 12,
wherein in the fourth device of each hierarchy in the hierarchical structure in which entity data of a part or all item of the metadata that is common is stored in the storage unit, identification information of the metadata is stored in the storage unit, and
wherein, in a case where the search request is a request to obtain the metadata having a specific identification information, the search control unit forwards the search request to the high-level device relative to the fourth device in the hierarchical structure in a case where the specific identification information is not stored in the storage unit, and the search control unit does not forward the search request to the high-level device relative to the fourth device in the hierarchical structure in a case where the specific identification information is stored in the storage unit.

19. The data management system according to claim 13,
wherein, in a case where the metadata having the specific identification information requested by the search request is stored in the storage unit, and in a case where entity data of an item requested by the search request among the metadata having the specific identification information is not stored in the storage unit, the search control unit forwards the search request to the low-level device in the hierarchical structure indicated by the link information corresponding to the metadata stored in the storage unit.

20. The data management system according to claim 13,
wherein, in a case where the metadata having the specific identification information requested by the search request is stored in the storage unit, and in a case where entity data of an item requested by the search request among the metadata having the specific identification information is not stored in the storage unit, the search control unit acquires entity data of the item requested by the search request from the low-level device in the hierarchical structure indicated by the link information corresponding to the metadata stored in the storage unit.
